(19) United States
(12) Patent Application Publication
(10) Pub. No.: US 2011/0154192 A1
(43) Pub. Date: Jun. 23, 2011

(54) Multimedia Collaboration System

(76) Inventors: Jinyu Yang, Fremont, CA (US); Xuan Zhang, San Jose, CA (US); Shi Yan, Fremont, CA (US); Bing Tang, Shanghai (CN); Zhiwei Shen, Zhe-Jiang (CN)

(21) Appl. No.: 13/001,805

(22) PCT Filed: Jun. 25, 2010
(86) PCT No.: PCT/CN2010/074481

§ 371 Date: Dec. 29, 2010

Related U.S. Application Data
(60) Provisional application No. 61/222,090, filed on Jun. 30, 2009.

(51) Int. Cl. G06F 17/24; G06F 15/16

(52) U.S. Cl. 715/256; 709/217

(57) ABSTRACT

A collaboration system includes a remote server system and one or more client devices connected to the remote server system, at least one of which being a first client device that includes a touch screen display. Upon receipt of a user instruction, the collaboration system opens a document at the first client device and displays the document on the touch screen display to a first user. The collaboration system detects a first comment on the document from the first user through interacting with the touch screen display. The collaboration system receives a second comment on the document from the remote server system. The second comment is generated by a second user of a second client device and transmitted to the remote server system through a computer network. The collaboration system displays, concurrently, the first comment and the second comment on the touch screen display.

### TECHNICAL FIELD

The disclosed embodiments relate generally to a multimedia collaboration system, and in particular, to system and method for data sharing between users of a multimedia collaboration system.

### BACKGROUND

Computer network (e.g., Internet and Intranet) has become a powerful tool for people at different locations to communicate with each other. For example, many companies now use web conferences to conduct work-related live meetings or presentations. Through the A/V capturing and broadcasting equipment, web conferencing brings people across the world into a virtual conference room in the Cyberspace. Although the attendees of a web conference can see each other and hear each other almost in real time, the interactivity of their communication is tampered by the fact that the attendees in a virtual conference room cannot easily share their comments in handwriting through computers as a group of attendees can do in a real-life conference room that is equipped with a large whiteboard.

### SUMMARY

In accordance with some embodiments described below, a computer-implemented method performed by a collaboration system is disclosed. The collaboration system includes a remote server system and one or more client devices including a first client device that includes a touch screen display and connected to the remote server system. Upon receipt of a user instruction, the collaboration system opens a document at the first client device and displays the document on the touch screen display to a first user. The collaboration system detects a first comment on the document from the first user through interacting with the touch screen display. The collaboration system receives a second comment on the document from the remote server system. The second comment is generated by a second user of a second client device and transmitted to the remote server system through a computer network. The collaboration system displays, concurrently, the first comment and the second comment on the touch screen display.

In accordance with some embodiments described below, a server system includes one or more processing units for executing programs and memory for storing data and one or more programs to be executed by the one or more central processing units. The one or more programs including instructions for: receiving a first comment on a document made by a first user from a first client device and a second comment on the document made by a second user from a second client device, wherein the document is a subject of a web conference supported by the server system; storing the first and second comments in a data structure associated with the document, each comment having an associated timestamp; and transmitting, respectively, the first comment to the second client device and the second comment to the first client device such that the first and second comments are concurrently displayed on both the first and second client devices.

In accordance with some embodiments described below, a computer readable-storage medium stores one or more programs for execution by one or more processors of a server system. The one or more programs comprise instructions, which when executed by the one or more processors, cause the server system to: receive a first comment on a document made by a first user from a first client device and a second comment on the document made by a second user from a second client device, wherein the document is a subject of a web conference supported by the server system; store the first and second comments in a data structure associated with the document, each comment having an associated timestamp; and transmit, respectively, the first comment to the second client device and the second comment to the first client device such that the first and second comments are concurrently displayed on both the first and second client devices.

### BRIEF DESCRIPTION OF DRAWINGS

The aforementioned embodiment of the invention as well as additional embodiments will be more clearly understood as a result of the following detailed description of the various aspects of the invention when taken in conjunction with the drawings. Like reference numerals refer to corresponding parts throughout the several views of the drawings.

FIG. 1 is a block diagram of a collaboration system in accordance with some embodiments.

FIG. 2 is a block diagram that depicts how a first user at a touch screen whiteboard exchanges comments with a second user at a desktop computer in accordance with some embodiments.

FIGS. 3A and 3B are block diagrams of data structures in accordance with some embodiments.

FIGS. 4A to 4C are flow charts illustrating how different client devices of a collaboration system share comments on a document in accordance with some embodiments.

FIGS. 5A to 5D are flow charts illustrating how a server system of a collaboration system coordinates different client devices to share comments on a document in accordance with some embodiments.

FIG. 6 is a block diagram of a client device in accordance with some embodiments.

FIG. 7 is a block diagram of a server system in accordance with some embodiments.

### DESCRIPTION OF EMBODIMENTS

Reference will now be made in detail to embodiments, examples of which are illustrated in the accompanying drawings. While the invention will be described in conjunction with the embodiments, it will be understood that the invention is not limited to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

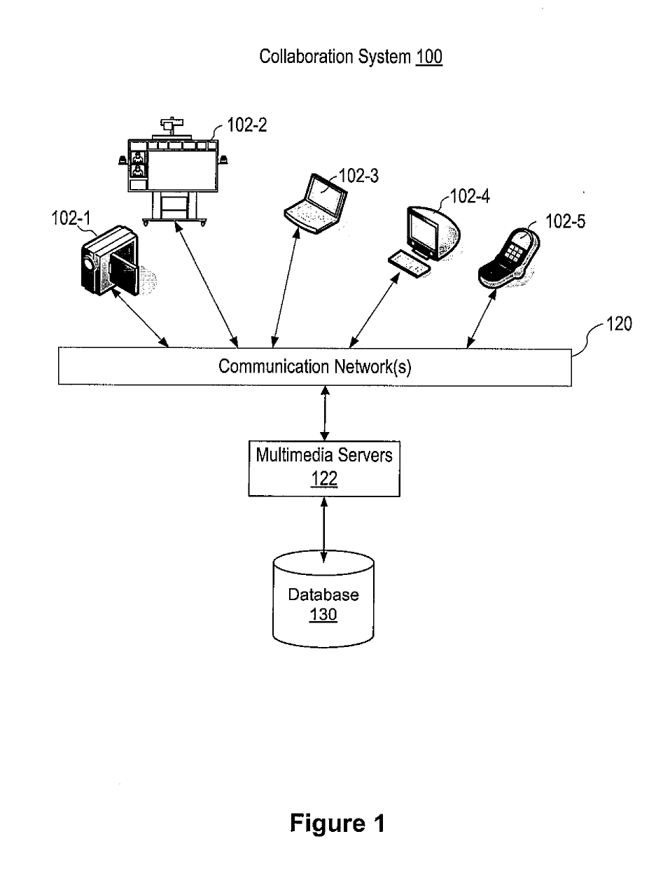

FIG. 1 illustrates a distributed collaboration system 100, suitable for practice of embodiments of the invention. The collaboration system 100 may include one or more client devices 102 that are located remotely from one or more multimedia servers 122. A respective client device 102 (also known as a client or client system) may be a video camera 102-1, a large touch screen whiteboard 102-2, a laptop computer 102-3, a desktop computer 102-4, a cell phone 102-5, or the like such as a kiosk, a personal digital assistant, etc. A communication network 120 connects the client devices 102 to the multimedia servers 122, which have access to a database 130. For illustration, it is assumed that the collaboration system 100 is currently hosting a web conference and different types of data such as text, video, audio and image are transmitted through the communication network 120 between the client devices 102 and the multimedia servers 122.

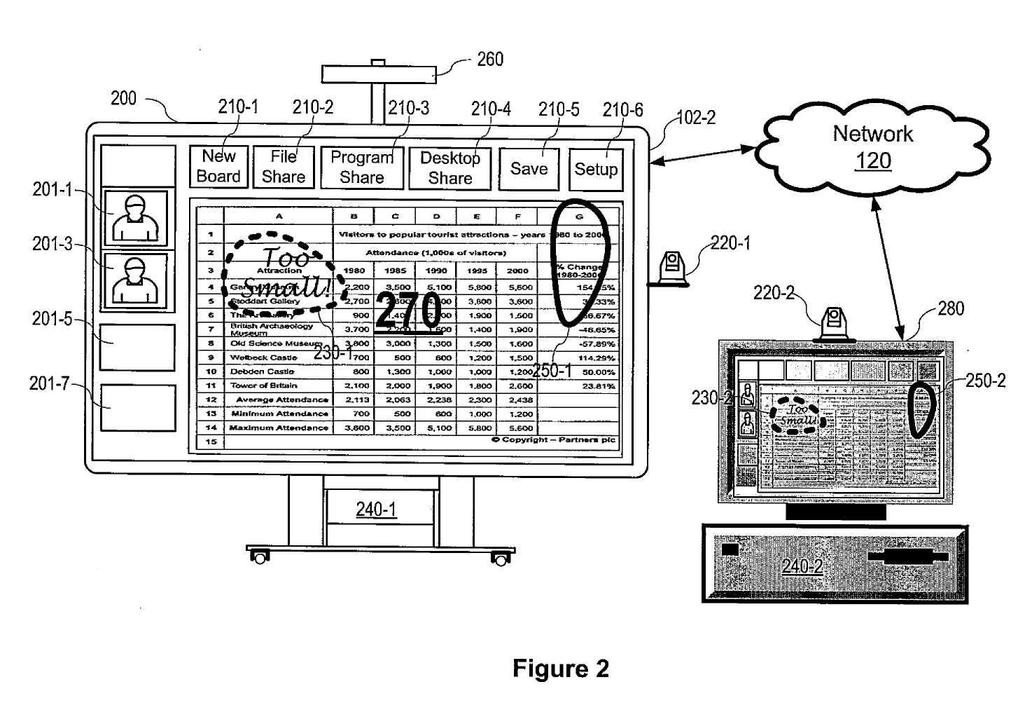

Note that the types and numbers of client devices that are involved in a web conference, to some extent, depend on the subject of the web conference. For example, if the web conference is a class given by a teacher to a group of students at remote locations, there are probably at least one touch screen whiteboard 102-2 at which the teacher gives lecture and multiple laptops 102-3 and/or desktops 102-4 at different geographical locations, one for each student in the class. As will be explained below in connection with FIG. 2, comments made by the teacher and the students can be posted on the whiteboard 102-2 and the monitors of the respective computers.

In some embodiments, the web conference is a group discussion of a product design between two groups of engineers of a company at two different locations, e.g., group A at the company's Silicon Valley office in the United States and group B at the company's Hangzhou office in China. In this case, each group of engineers is gathered in a local conference room that has a touch screen whiteboard 102-2. To facilitate the discussion, the product design is displayed on both touch screen whiteboards for the respective group members. If a member of group A at the Silicon Valley office decides to makes any suggestion, he or she can come to the touch screen whiteboard and use tools (e.g., a stylus or a finger) to write comments on the whiteboard. Through the communication network 120 and the multimedia servers 122, the comments are transmitted to the touch screen whiteboard located at the Hangzhou office and displayed to the group of engineers in the conference room. By the same token, a person at the Hangzhou office can make comments in the same manner, which are then transmitted back to the Silicon Valley office and displayed to the local group of engineers. Note that terms such as “comment,” “remark,” “change,” or “ revision” throughout the present application may refer to text or drawings or a mixture of both made by a person at a client device. The transmission of a comment or a document may be the transmission of the comment or document itself or one or more images of the comment or document.

In some embodiments, the group discussion of a product design has multiple stages. During the first stage, one group of engineers gathers at a conference room that is equipped with a touch screen whiteboard and comes up with one or more product designs using the touch screen whiteboard. Each of the designs is saved in one or more documents at the touch screen whiteboard or at a remote server. Subsequently, a web conference is organized to allow the group of engineers to share its product designs with attendees at other remote locations and solicit verbal or written comments from others. To do so, the saved documents that include the product designs are distributed within the collaboration system to different client devices. New comments from different attendees are added onto the designs and exchanged between the client devices.

In some embodiments, the web conference employs a video camera 102-1 to monitor an object (e.g., a building under construction). A group of construction professionals may be gathered in a remote conference room equipped with the touch screen whiteboard to discuss the issues related to the building construction progress and an individual on travel may be able to join the discussion from a client device such as a laptop computer 102-3 or even a cell phone 102-5. Similarly, an attendee of the web conference can communicate his or her thoughts to the other attendees via video signal or audio signal as well as written comments.

Note that different client devices may have different input means or different input capacities. For example, some of the client devices such as the whiteboard 102-2 allow a user to input his or her comments by directly interacting with the touch screen display while others allow a user to enter comments through one or more devices such as a mouse or keyboard or both. In some embodiments, some of the client devices (e.g., a cell phone) may allow a user to provide verbal comments, but not anything in writing.

FIG. 2 is a block diagram that depicts how a first user at a touch screen whiteboard exchanges comments with a second user at a desktop computer in accordance with some embodiments. For simplicity, certain components of the collaboration system shown in FIG. 1, e.g., the multimedia servers 122 and the database 130 are omitted.

In some embodiments, the touch screen whiteboard 102-2 includes:
a large (e.g., 60-120 inches in the diagonal direction) touch-sensitive whiteboard 200;
a computer system 240-1 that manages the touch-sensitive whiteboard 200;
one or more video monitors 220-1 that are coupled to the computer system 240-1 for capturing video images of user and/or objects in front of the whiteboard; and
a front projector 260 that is coupled to the computer system 240-1 for projecting computer-generated images onto the whiteboard 200.

An exemplary touch-sensitive whiteboard for the collaboration system is the HiteVision™ Interactive Electronic Whiteboard manufactured and sold by Beijing Honghe Technology Group at httn://www.honghe-tech.com. Note that the front projector 260 is optional if the touch-sensitive whiteboard is replaced with a touch screen display that is capable of generating and displaying digital images. For the rest of this application, the terms “touch-sensitive whiteboard” and “touch screen display” are used interchangeably.

In some embodiments, the surface of the touch-sensitive whiteboard 200 is divided into multiple regions, including:
A dialogue region (e.g., the dialogue region 201 on the left side of the touch-sensitive whiteboard 200 in FIG. 2)—The dialogue region 201 further including multiple windows 201-1, 201-3, each window showing the video signal generated by a respective client device; and in some embodiments, one of the windows shows the video signal captured by the video monitor 220-1 and another one of the windows 201-5 displays a list of registration entries, each entry including the identity of an attendee at a particular client device and the attendee's registration privilege; and in some embodiments, the dialogue region 201 includes a textbox 201-7 for a user to input text through a keyboard attached to the computer system 240-1;
A control region (e.g., the control region 210 at the top of the touch-sensitive whiteboard 200 in FIG. 2)—The control region 201 further including multiple tabs 210-1 to 210-6, each tab corresponding to a function supported by the collaboration system 100 such as New Board 210-1, File Share 210-2, Program Share 210-3, Desktop Share 210-4, Save 210-5, and Setup 210-6 (note that a more detailed description of these functions is provided below); and
A content display region (e.g., the content display region 270 that occupies the region of the touch-sensitive whiteboard 200 in FIG. 2 that is not occupied by other objects)—The content display region 270 being configured to display an entity that is typically a subject being discussed by participants of the web conference, e.g., a spreadsheet document as shown in the figure.

Referring to FIG. 2, the touch screen whiteboard 102-2 is coupled to a desktop computer through the network 120. The desktop computer includes a computer monitor 280 for displaying images processed by a computer, system 240-2 and a video monitor 220-2 for capturing the images of a user in front of the computer monitor 280. In this example, a user at the desktop computer registers for the web conference and thus the information that appears on the touch-sensitive whiteboard 200 is rendered on the computer monitor 280.

In some embodiments, attendees of the web conference can express their opinions on the subject of the conference (e.g., the spreadsheet 270) in different ways. Some attendees may make comments verbally through microphones attached to or within the client devices. Audio signals captured by the microphones are further processed (such as digitizing, noise filtering, data compressing, packetizing, etc.) by computer processors within the client devices and then transmitted to the rest of the collaboration system including the other client devices and the multimedia servers. In some embodiments, the images of an attendee at a client device may be captured by a video monitor 220-1, 220-2. A computer system then performs one or more data processing operations to the captured video signals and converts them into a stream of data packets that are suitable for network communication. There are many well-known video and audio data processing algorithms that are applicable to the embodiments of the present application.

In some embodiments, the audio and video signal packets are transmitted over the network 120 using many well-known standard network communication protocols such as UDP, TCP, HTTP, RTP, and SRTP. In some other embodiments, the audio and video signal packets are transmitted over the network 120 using proprietary network communication protocols.

In some embodiments, besides the attendees of a web conference can make written comment on the subject currently being discussed by the attendees. For example, an attendee at the touch screen whiteboard 102-2 (FIG. 2) uses a pen to draw a circle 230-1 on the column A of the spreadsheet 270 and then writes the phrase “Too-Small” by hand inside the circle to suggest that the font size of the text in the column A should be increased. This comment or a representation of the comment is transmitted over the network to and displayed on the other client devices such as a copy 230-2 of the phrase on the computer monitor 280 of the desktop computer. Similarly, the attendee at the desktop computer can draw another circle 250-2 on the spreadsheet through its input/output device (e.g., a mouse). This circle or a representation of the circle is transmitted to and displayed on the touch-sensitive whiteboard 200 as the circle 250-1 on the touch-sensitive whiteboard 200. In some embodiments, when one attendee at a client device scrolls the spreadsheet 270 up and down, the comments are also moved accordingly at the client device as well as other client devices that attend the web conference.

In some embodiments, comments or remarks made by different attendees from different client devices are displayed in visually distinguishable manners. For example, as shown in FIG. 2, the first circle 230-1 drawn by the attendee at the touch screen whiteboard 102-2 is shown in dashed-line format and the second circle 250-2 drawn by the attendee at the desktop computer is shown in solid-line format. One advantage with displaying different attendees' comments in different styles is to help the attendees from different sites to understand who is responsible for making what comments. This feature is particularly useful if the collaboration system is used by a teacher to give a lecture to a distributed group of students. In this case, students at different locations can easily recognize the teacher's comments from a student's comments if they are being rendered in different styles. In some embodiments, the comment-writing style differences include line type, line color, line thickness, or other features easily-recognizable by the attendees of a web conference.

In some embodiments, the collaboration system is configured such that the attendees from different types of client devices all have a default comment-writing style and an individual attendee can choose his or her own style from a list of candidate styles. In some embodiments, the collaboration system assigns a set of predefined comment-writing styles to a client device based on the type of the device. For example, there are usually multiple attendees participating through the touch screen whiteboard 102-2. Thus, more comment-writing style options may be given to the touch screen whiteboard 102-2 so that different attendees at the touch screen whiteboard 102-2 can choose different styles to distinguish one attendee's comment from another one's comment. In some embodiments, the collaboration system assigns a set of predefined comment-writing styles to an attendee in accordance with the attendee's user profile. For example, to attend a web conference, an attendee needs to log into the collaboration system by inputting his or her username and password. Upon receipt of the attendee's identification information, the collaboration system can retrieve the attendee's user profile from its database and the user profile may include information such as the attendee's privilege. Some of the attendees may be labeled as “host” and have the right to use all the resources of the collaboration system, including having more comment-writing styles to choose. Some of the attendees may be labeled as “presenter” and have limited right to use the resources of the collaboration system. Some of the attendees may be labeled as “audience” and have even less privilege than a presenter attendee. In some embodiments, the classification of attendees' participation level is important for allocating the collaboration system's resources as well as keeping a web conference in reason order, e.g., by preventing ill-intended attendees from disrupting the conference.

In some embodiments, the subject being discussed among the attendees may not have any pre-existing document. But if an attendee at a particular client device (e.g., the touch screen whiteboard 102-2) prefers to share his or her thoughts in writing, the attendee can touch the New Board icon 210-1 by hand or other tools. The touch screen whiteboard 102-2 then brings up a virtual whiteboard in the content display region 270. Through the computer network and the multimedia servers, a virtual whiteboard is also rendered on the displays of the other client devices such as the desktop computer's monitor 280. Next, each attendee can write his or her thoughts or comments on a respective local virtual whiteboard, which are then transmitted to and displayed on other virtual whiteboards supported by the collaboration system. This feature is especially useful when two groups of engineers at different locations discuss a joint project.

In some embodiments, the topic of a web conference may be a software program being executed at one of the client devices or the multimedia servers. For example, two or more attendees from different sites, one being a web page designer at the touch screen whiteboard 102-2 and the other being a customer at the desktop, may like to discuss a web page the designer prepares for the customer. In this case, the designer can touch the Program Share icon 210-3 and launch a web browser window on the content display region 270 to show the web page. The customer can then give feedbacks to the designer by writing comments on the monitor 280, which are transmitted to the touch screen whiteboard 102-2 and displayed on the touch-sensitive whiteboard 200.

In some embodiments, the web conference may be conducted between a user of a personal computer (PC) and a customer service representative of the manufacturer of the computer or a software company. For example, one reason for having the web conference is that the user encounters a problem with the PC or with an application running on the PC that is developed by the software company. In this case, the user can touch the Desktop Share icon 210-4 to bring up the PC's desktop in the content display region 270. Note that the PC being diagnosed may be connected to the computer 240-1 of the touch screen whiteboard 102-2 through a network connection. To help the customer service representative to diagnose and fix the problem, the user may make remarks on the PC's desktop displayed in the content display region 270 to guide the representative to identify the cause of the problem. The representative can also write comments on the image of the PC's desktop displayed on the monitor that the representative faces to communicate with the user on various aspects relating to the solution of the problem. The capability of sharing written comments is complimentary to other communication channels such as voice that the collaboration system supports. In some embodiments, this capability is particularly useful if, e.g., the user is not familiar with the operation of a computer or the software application being diagnosed.

In some embodiments, a web conference may be terminated or suspended for various reasons although the discussion over a particular topic has not reached a conclusion yet. For example, the attendees of the web conference shown in FIG. 2 have not agreed on how to update the spreadsheet when one of the key attendees may have to leave the conference to address a more urgent matter. In this case, the collaboration system provides an option for the attendees to save their comments written on the content display regions of the client devices. To invoke this option, one attendee at the touch screen whiteboard may select the Save icon 210-5 and cause the hand-written comments as well as the underlying document to be saved within a storage device. In some embodiments, the comments are saved in a local hard drive of a client device through which the attendee invokes the option such as the computer system 240-1 of the touch screen whiteboard 102-2. In some embodiments, the comments are sent to one of the multimedia servers 122 and saved in a storage device (e.g., the database 130 of FIG. 1) accessible to the multimedia server. Subsequently, when a new session of the web conference starts on the same topic, the attendees can re-open the document and its associated comments on the client devices' displays and resume the discussion. The comments being re-rendered on the displays offer the attendees a quick review of the previous discussions, e.g., who is responsible for which comment and what is the rationale associated with each comments. With this feature, the collaboration system can improve not only the interactivity between different attendees during a web conference but also the efficiency of the subsequent web conferences on the same subject.

In some embodiments, the collaboration system supports the re-rendering of the comments in a step-by-step manner. For example, it begins with rendering the underlying document and adding one comment at a time on the display until the last one. In some embodiments, the collaboration system implements this feature automatically (e.g., adding one comment every 30 seconds) and pauses in response to an instruction from a client device issued by an attendee (e.g., the host attendee). Alternatively, an attendee may perform this feature manually by pressing a button whenever he or she decides to add a new comment. In either case, one of the attendees can provide additional audio/video explanations about the comments to help the other attendees (especially those first-time attendees of the discussion) to understand better the thought flow of the previous discussions. At saving time, the collaboration system may provide data structures to support saving the comments in different formats (e.g., image, binary, or both).

In some embodiments, the collaboration system provides an option to print the underlying document and the comments on a printer or into a PDF document. If an attendee chooses to print out a hard or soft copy of the underlying document and the comments, the collaboration system may generate a set of slides based on the sequence of the comments being added on the document and then submit the set of slides to a physical printer or a virtual printer.

In some embodiments, an attendee can update the comments displayed in the content display region of a corresponding client device. For example, an attendee (e.g., a teacher who is giving a lecture) at the touch screen whiteboard 102-2 may be able to erase a previous comment made by him or her or anybody else who attends the lecture, move the comment to a different location on the whiteboard by dragging and dropping or rotating using multiple fingers on the touch-sensitive whiteboard, or change its appearance such as enlarging or shrinking. In some embodiments, an attendee (e.g., a student of a lecture) is by default allowed to update only his or her own comments.

In some embodiments, the collaboration system has a Setup icon 210-6 that enables an attendee (e.g., an administrator of the collaboration system or a host of a web conference) to configure the collaboration system based on the user profiles of different attendees. For example, the host can grant different levels of privilege to different attendees based on their roles during the conference. In some embodiments, the host may change the privilege level of an attendee if the attendee's role changes. For example, if a web conference permits only one presenter at a particular time and two attendees are supposed to give separate presentations, the host may designate one attendee to be the presenter and the other one to be an audience, and switch their privilege levels subsequently when the other presenter is to give presentation.

For illustration, the features are described above in conjunction with comments made on a document such as the example shown in FIG. 2. But it would be apparent to one skilled in the art that the features are by no means limited to this scenario and are equally applicable to the other situations. For example, a team of engineers at different locations may use the New Board 210-1 option of the touch screen whiteboard 102-2 to discuss a project. The features like save, replay, print of the comments made by the attendees would be very useful for them to have a more productive discussion.

Similarly, for illustration, the scenario shown in FIG. 2 includes a touch screen whiteboard 102-2 and a desktop computer. But all the features described above and the like can be implemented on other types of hardware client devices as along as the devices have necessary (wired or wireless) network connection and input/output means. For example, engineers at two remote locations may use two touch screen whiteboards 102-2 at the two locations to discuss a product design. Both sides have multiple attendees gathered in a conference room, who can attend the web conference through audio/video signals and handwritten comments on the respective whiteboards. In contrast, a webinar may involve one instructor who lectures in front of the touch screen whiteboard 102-2 and many student attendees, each sitting remotely in front of a PC. In this case, the PC may not have the video equipment since the focus of the webinar is on the instructor side. As another example, the subject of a web conference may be a physical object captured by one of the client devices such as the video camera 102-1 of FIG. 1. In this case, the image of the physical object is shown in the content display region through the options such as Program Share 210-3 or Desktop Share 210-4. Different attendees can make comments on the object in the same way as described above.

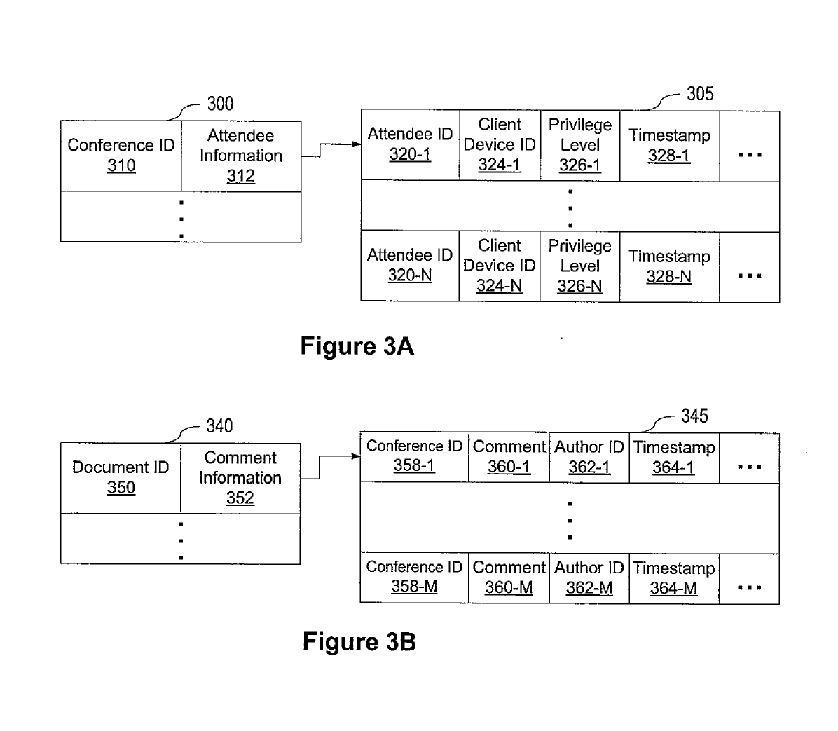

In some embodiments, the collaboration system may manage information about the web conferences and attendees of each web conference as well as documents and their associated comments using various data structures to support the features above. FIGS. 3A and 3B are block diagrams of data structures in accordance with some embodiments.

As show in FIG. 3A, the collaboration system stores the web conference information in a table 300. The table 300 includes multiple entries, each entry having a conference ID 310 assigned to a particular conference and the attendee information 312 of the conference. In some embodiments, the attendee information of a web conference is stored in another table 305 with a pointer linked to the corresponding entry in the table 300. Each entry in the table 305 includes:
an attendee ID (320-1, 320-N) that uniquely identifies an attendee of the web conference;
a client device ID (324-1, 324-N) that uniquely identifies a client device from which the attendee joins the conference;
a privilege level (326-1, 326-N) that represents the level of the privilege that the attendee is given by the collaboration system; and
a timestamp (328-1, 328-N) that indicates what time the attendee joins the web conference.

In some embodiments, the collaboration system treats different individuals that participate from the same client device as the same attendee. In this case, an attendee ID that is separate from the client device ID may be optional. In some embodiments, the attendee information may also include an attendee's account history that documents the attendee's past activities of using the collaboration system and the account's balance if, e.g., the collaboration system is managed by the web conference service provider.

As shown in FIG. 3B, the collaboration system stores information about the documents discussed during the web conferences in a table 340. The table 340 includes multiple entries, each entry having a document ID 350 assigned to a particular document and the comment information 352 related to the document. In some embodiments, the document ID 350 identifies the document's location using a text string (e.g., a URL) or the like and this location may be at the client device or at the server side. In some embodiments, the comment information of a document is stored in another table 345 with a pointer linked to the corresponding entry in the table 340. Each entry in the table 345 includes:
a conference ID (358-1, 358-M) that uniquely identifies a web conference that the comment is associated with;
a comment (360-1, 360-M) that represents the content of a particular comment about the document;
an author ID (362-1, 362-M) that uniquely identifies an attendee that makes the comment (e.g., using the corresponding attendee ID); and
a timestamp (364-1, 364-M) that indicates what time the comment is made.

In some embodiments, the collaboration system treats different individuals that participate from the same client device as the same attendee. In this case, the author ID is the same as the client device ID. In some embodiments, the comment is an image of the content display region of a client device that is generated after an attendee signals a completion of the comment. In some embodiments, the comment is a set of images (e.g., in the form of a video stream) that captures the movement of the I/O device (e.g., a user's finger in the case of a touch-sensitive display) when writing the comments on the content display region.

A single comment as defined and processed by the collaboration system may or may not be the same as the one that is understood by the attendees of a web conference. For example, the attendees may treat the circle 250-1 as a single comment because it is made by a particular author for a specific purpose. But for technical regions such as ease of processing or storage, the collaboration system may choose to split the circle into multiple segments, each segment being a single comment and occupying one entry in the table 345.

Although FIG. 3B depicts a data structure for storing a document and its associated comments, it can be readily adapted to handle the other types of discussion topics such as a virtual whiteboard, a shared program, or a shared desktop. For example, the collaboration system may generate an image file (e.g., a snapshot) for the virtual whiteboard, the shared program or desktop as the document being commented. It should be noted that the term “document” as used throughout the present application refers to any digital information item that can be managed by a computing device and transmitted across a computer network. Exemplary documents include a text document, a digital image, a desktop, a computer program, etc.

In some embodiments, the document is initially located at a client device (e.g., within a USB flash drive attached to the client device). After an attendee opens the document on the display of the client device, the collaboration system (more specifically, some application at the client device) generates an image of the displayed document and transmits the image to the other client devices that have registered the web conference through the network. In some embodiments, the image data is first transmitted from the client device to a first multimedia server that is close to the client device. The first multimedia server either directly transmits the image to an identified client device or forwards the image to a second multimedia server if the second multimedia server has a more efficient communication channel.

In some embodiments, the document is initially located at a multimedia server. In this case, an attendee can remotely open the document at a client device by submitting a request to the server. The multimedia server, in response, generates images of the document and transmits the images to the other servers and ultimately to all the client devices (including the client device from which the attendee submits the request). In some embodiments, a client-side document is processed in substantially the same manner as a server-side document. That is, the collaboration system first copies the document from a client device to a multimedia server in response to a user instruction to open the client-side document. Next, the server manages to generate images for the document and transmit the images to different client devices.

In some embodiments, the collaboration system is responsible for compressing the image data before the data leaves the data source (e.g., a multimedia server) and for decompressing the compressed image data after the data reaches the destination (e.g., a client device). By doing so, the collaboration system can increase its network throughput. Many well-known data compression techniques can be used by the collaboration system, one of which is the technique of calculating the difference between two consecutive images and compressing/decompressing the image difference. In some embodiments, the collaboration system transmits the (compressed) image packets over the network 120 using standard network communication protocols such as UDP, TCP, HTTP, RTP, and SRTP. In some other embodiments, the image packets are transmitted over the network 120 using proprietary network communication protocols.

In some embodiments, the collaboration system handles the comments being shared among the attendees of a web conference in substantially the same manner as it does with the document. For example, upon detecting that one attendee is writing a comment on the display of a client device, the client device generates one or more images for the comment and transmits the images to a nearby multimedia server in the same way as it transmits document images. The multimedia server inserts new entries in the corresponding tables 340 and 345 for the comment images and forwards the images to the other client devices that attend the conference by looking up the information in the tables 300 and 305.

In some embodiments, the transmission of document or comment image data between the client devices is performed in accordance with a peer-to-peer model and there is no centralized server like the multimedia server in FIG. 1 that manages the client devices. Instead, the conference information and comment information described above are distributed across multiple client devices so that each client device knows how to communicate data such as document and comments with others.

In some embodiments, the collaboration system organizes a plurality of multimedia servers into a hierarchical structure. A server at a higher level of the hierarchy manages a group of servers at a lower level of the hierarchy. Each server at the lowest level of the hierarchy is connected to a plurality of client devices of different types. In some embodiments, one client device is connected to multiple servers at the lowest level of the hierarchy and it maintains a list of those servers that it has connections to. When a user at the client device attempts to join an existing web conference, the client device checks the availability of the servers in the list to link to a server that has the necessary resource (e.g., bandwidth) to support this conference based on, e.g., the level of privilege that the user is authorized. Next, the server contacts with the other servers (e.g., the servers at higher levels of hierarchy) to retrieve information such as the attendee list, the document being discussed, and the comments made by others on the document. Such information is transmitted to the client device so that the user can catch up with the other attendees of the meeting and probably share his or her comments as well.

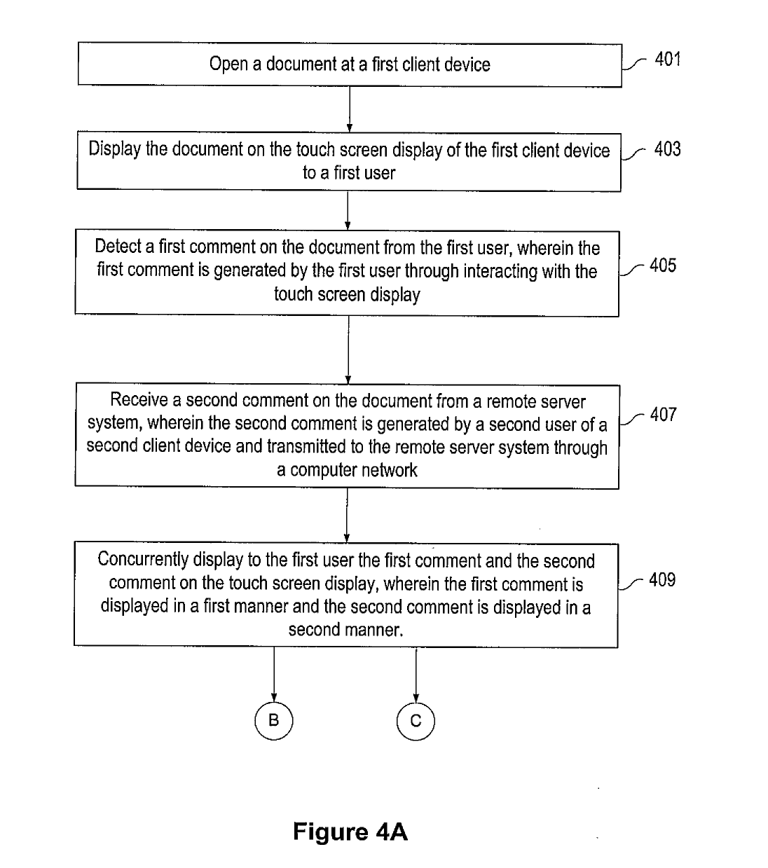

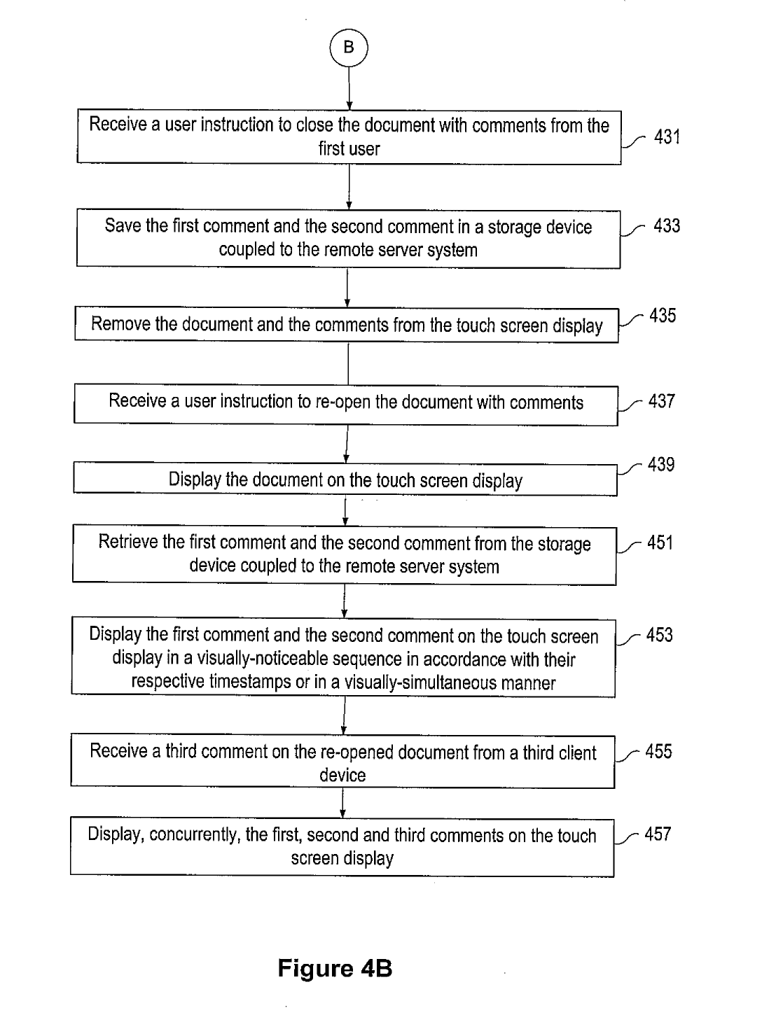

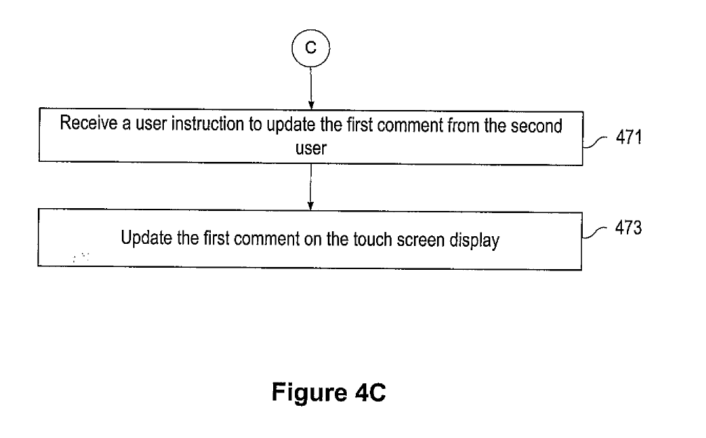

FIGS. 4A to 4C are flow charts illustrating how different client devices of a collaboration system share comments on a document during a web conference in accordance with some embodiments. In some embodiments, the method is implemented by a collaboration system that includes a remote server system and one or more client devices connected to the remote server system.

As shown in FIG. 4A, an attendee submits an instruction to open a document at a first client device that includes a touch screen display (401). Upon receipt of the instruction, the first client device displays the document on the touch screen display to a first user of the first client device (403). Subsequently, the first client device detects a first comment on the document from the first user (405). In some embodiments, the first comment is generated by the first user through interacting with the touch screen display (e.g., finger touches). The first client device receives a second comment on the document from the remote server system that is responsible for coordinating the web conference (407). In some embodiments, the second comment is generated by a second user of a second client device and transmitted to the remote server system through a computer network. Note that the second client device may or may not have the same hardware configuration as the first one. For example, the second one may not have a touch screen display. After receiving the two comments, the first client device concurrently displays the first comment and the second comment on the touch screen display (409). In some embodiments, the first comment is displayed on the touch screen display in a first manner (e.g., in red) and the second comment is displayed on the touch screen display in a second manner (e.g., in blue) that is different from the first manner. In some embodiments, the first comment is concurrently displayed at the first client device and the second device in the first manner and the second comment is concurrently displayed at the first client device and the second device in the second manner.

As shown in FIG. 4B, in response to a user instruction to close the document with comments (431), the first client device saves the first comment and the second comment in a storage device coupled to the remote server system (433), each comment having an associated timestamp. In some embodiments, the comments are first saved at the client device and then transmitted to the remote server system. The first client device also terminates the display of the document and the first and second comments on the touch screen display (435).

In response to a user instruction to re-open the document with comments (437), the first client device displays the document on the touch screen display (439). In some embodiments, this operation may involve the retrieval of the document from the server system if the client device does not have a copy of the document. Additionally, the first client device retrieves the first comment and the second comment from the storage device (451) and displays the first comment and the second comment on the touch screen display in a visually-noticeable sequence in accordance with their respective timestamps or in a visually-simultaneous manner (453). For example, the comments are introduced on the touch screen display one by one with a time interval between two consecutive ones. In another example, if all the comments are present in the same image, they will appear on the touch screen display at the same time. In some embodiments, the first client device may receive a third comment on the re-opened document from a third client device (455). In this case, the three comments will be displayed concurrently on the touch screen display (457).

As shown in FIG. 4C, the first client device receives one or more user instructions to update the first comment from the second user (471). For example, the second user may have a higher level of privilege to update other attendees' comments. In this case, the first client device can update the first comment on the touch screen display in accordance with the user instructions from the second client device (473). In some embodiments, the user instructions include an image of the updated first comment. In some embodiments, the user instructions are to remove the first comment. In this case, the first client device removes the first comment from the touch screen display.

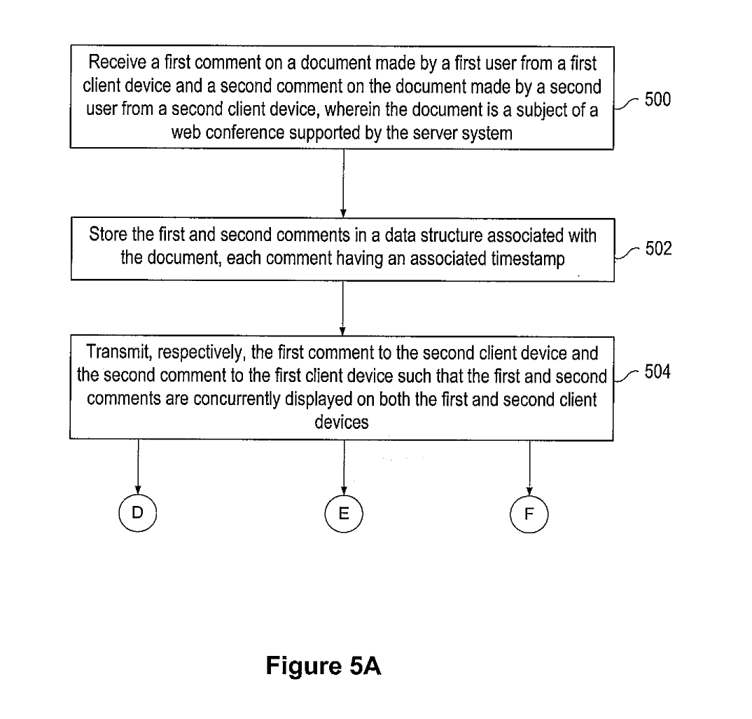

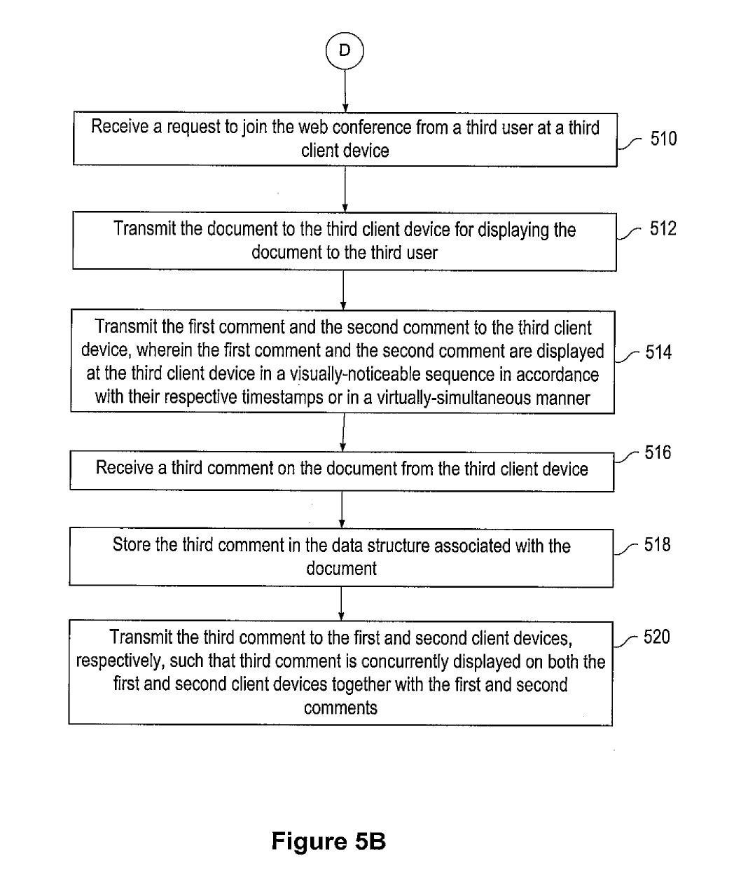

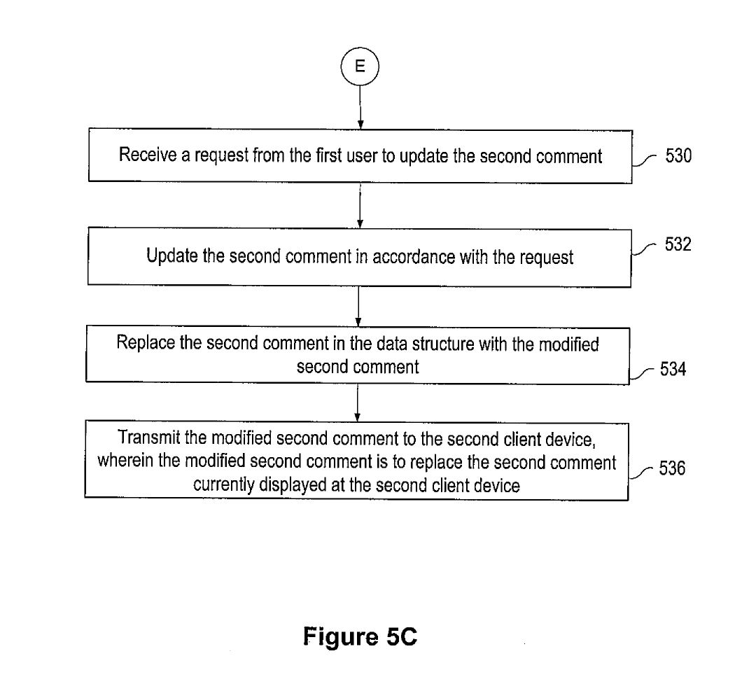

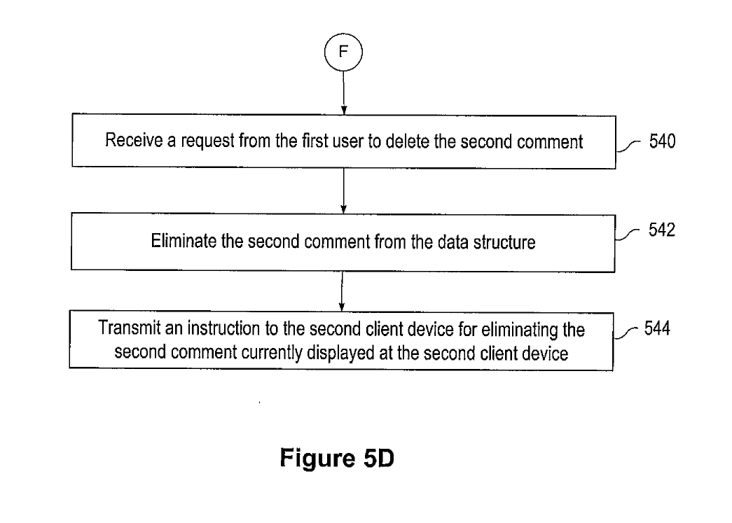

FIGS. 5A to 5D are flow charts illustrating how a server system of a collaboration system coordinates different client devices to share comments on a document during a web conference in accordance with some embodiments.

As shown in FIG. 5A, in response to receiving a first comment on a document made by a first user from a first client device and a second comment on the document made by a second user from a second client device (500), the server system stores the first and second comments in a data structure associated with the document, each comment having an associated timestamp (502). FIG. 3B illustrates a data structure for such purpose. The server system also transmits, respectively, the first comment to the second client device and the second comment to the first client device such that the first and second comments are concurrently displayed on both the first and second client devices (504).

In some embodiments (FIG. 5B), in response to a request to join the web conference from a third user at a third client device (510), the server system transmits the document to the third client device for displaying the document to the third user (512). In addition, the server system also transmits the first comment and the second comment to the third client device (514) such that the third client device can display the first comment and the second comment in a visually-noticeable sequence in accordance with their respective timestamps or in a visually-simultaneous manner.

In some embodiments, upon receiving a third comment on the document from the third client device (516), the server system stores the third comment in the data structure associated with the document (518) and transmits the third comment to the first and second client devices (520), respectively, such that third comment is concurrently displayed on both the first and second client devices together with the first and second comments.

As shown in FIG. 5C, in response to a request from the first user to update the second comment (530), the server system updates the second comment in accordance with the request (532) and replaces the second comment in the data structure with the modified second comment (534). In addition, the server system transmits the modified second comment to the second client device (536). In some embodiments, the second client device will use the modified second comment to replace the original version of the second comment currently displayed at the second client device.

As another example shown in FIG. 5C, in response to a request from the first user to delete the second comment (540), the server system eliminates the second comment from the data structure (542). In some embodiments, the server system may not physically eliminate the comment but mark it with a flag indicating that it has been “virtually” eliminated. But the server system can reinstate the comment if necessary. Next, the server system transmits an instruction to the second client device for eliminating the second comment currently displayed at the second client device (544). In some embodiments, the instruction includes an image of the document without the second comment.

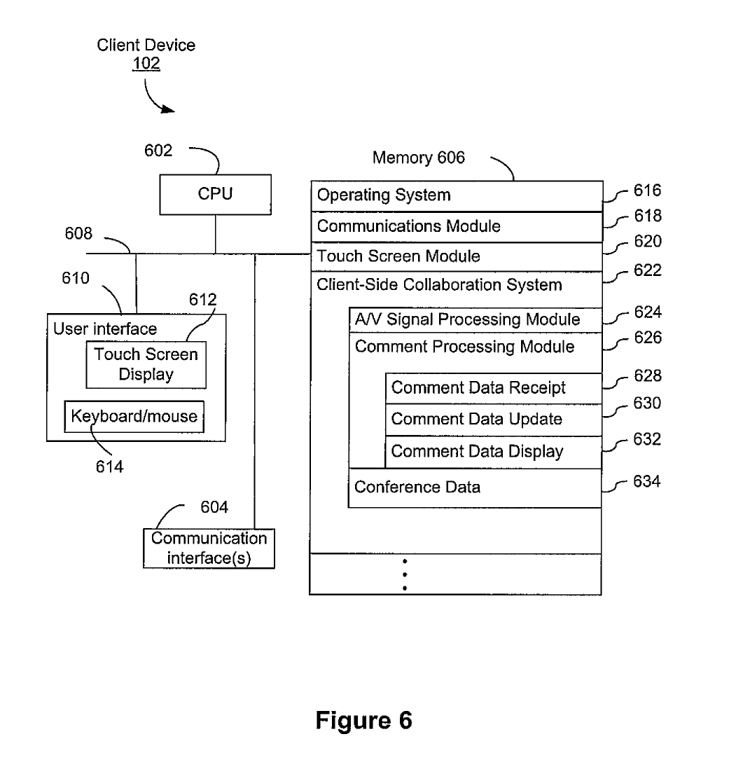

FIG. 6 is a block diagram of a client device 102 (e.g., the touch screen whiteboard 102-2) that implements the methods described above in accordance with some embodiments. The client device 102 includes one or more processing units (CPU's) 602, one or more network or other communications interfaces 604, memory 606, and one or more communication buses 608 for interconnecting these components. In some embodiments, fewer and/or additional components, modules or functions are included in the client device 102. The communication buses 608 may include circuitry (sometimes called a chipset) that interconnects and controls communications between system components. The client 102 may optionally include a user interface 610. In some embodiments, the user interface 610 includes a touch screen display 612 and/or a keyboard/mouse 614, but other configurations of user interface devices may be used as well. Memory 606 may include high speed random access memory and may also include non-volatile memory, such as one or more magnetic or optical storage disks, flash memory devices, or other non-volatile solid state storage devices. The high speed random access memory may include memory devices such as DRAM, SRAM, DDR RAM or other random access solid state memory devices. Memory 606 may optionally include mass storage that is remotely located from CPU's 602. Memory 606, or alternately the non-volatile memory device(s) within memory 606, comprises a computer readable storage medium. Memory 606 stores the following elements, or a subset of these elements, and may also include additional elements:
an operating system 616 that includes procedures for handling various basic system services and for performing hardware dependent tasks;
a network communication module (or instructions) 618 that is used for connecting the client device 102 to other computers via the one or more communications network interfaces 604 and one or more communications networks, such as the Internet, other wide area networks, local area networks, metropolitan area networks, and so on;
a touch screen module 620 that includes instructions for processing user interactions with the touch screen display 612; and
a client-side collaboration system 622, which includes: an audio/video signal processing module 624 for capturing audio/video signals generated at the client device 102; a comment processing module 626 for processing comments generated by the client device 102 or received from other client devices or multimedia servers; and web conference data 634 that includes, e.g., a list of multimedia servers accessible to the client device 102.

In some embodiments, the comment processing module 626 may include sub-modules for performing the following functions: comment data receipt 628 (including receiving comment data generated by the client device 102 or received from other sources); comment data update 630 (including moving comments around on the touch screen display 612, changing their shapes, or removing comments from the touch screen display 612); and comment data display 632 for rendering the received comment data on the touch screen display 612.

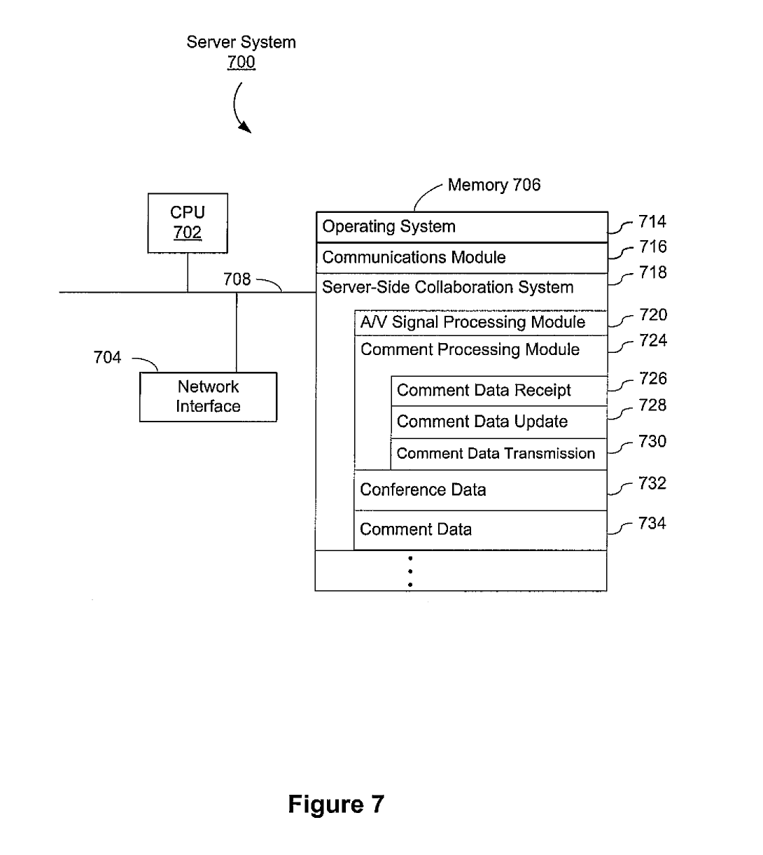

FIG. 7 depicts an embodiment of a server system 700 that implements the methods described above. The server system 700 corresponds to the multimedia servers 122 in FIG. 1. The server system 700 includes one or more processing units (CPU's) 702, one or more network or other communications interfaces 704, memory 706, and one or more communication buses 708 for interconnecting these components. The communication buses 708 may include circuitry (sometimes called a chipset) that interconnects and controls communications between system components. It should be understood that in some other embodiments the server system 700 may be implemented using multiple servers so as to improve its throughput and reliability. Thus, FIG. 12 is intended more as functional description of the various features which may be present in a set of servers than as a structural schematic of the embodiments described herein. The actual number of servers used to implement a server system 700 and how features are allocated among them will vary from one implementation to another, and may depend in part on the amount of data traffic that the system must handle during peak usage periods as well as during average usage periods.

Memory 706 may include high speed random access memory and may also include non-volatile memory, such as one or more magnetic or optical storage disks, flash memory devices, or other non-volatile solid state storage devices. The high speed random access memory may include memory devices such as DRAM, SRAM, DDR RAM or other random access solid state memory devices. Memory 706 may optionally include mass storage that is remotely located from CPU's 702. Memory 706, or alternately the non-volatile memory device(s) within memory 706, comprises a computer readable storage medium. Memory 706 stores the following elements, or a subset of these elements, and may also include additional elements:
an operating system 714 that includes procedures for handling various basic system services and for performing hardware dependent tasks;
a network communication module (or instructions) 716 that is used for connecting the server system 700 to other computers via the one or more communications network interfaces 704 and one or more communications networks, such as the Internet, other wide area networks, local area networks, metropolitan area networks, and so on; and
a server-side collaboration system 718 for coordinating data communication between different client devices during a web conference.

In some embodiments, the server-side collaboration system 718 may include the following elements, or a subset of these elements, and may also include additional elements:
an audio/video signal processing module 720 for receiving audio/video signals from one client device and forwarding them to the other client devices;
a comment processing module 724 for processing comments received from different client devices including storing them in the comment data structure 734; and
web conference data 732 that includes a list of web conferences and their registration information.

In some embodiments, the server-side comment processing module 724 works in concert with the client-side comment processing module 626 to perform the following functions: comment data receipt 726 (including receiving comment data submitted by the client devices 102 or other server systems); comment data update 728 (including updating the comment data 734); and comment data transmission 730 for forwarding original or updated comment data to the respective client devices or other server systems.

Although some of the various drawings illustrate a number of logical stages in a particular order, stages which are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method implemented by a collaboration system that includes a remote server system and one or more client devices connected to the remote server system, comprising:
at a first client device that includes a touch screen display,
opening a document at the first client device;
displaying the document on the touch screen display to a first user of the first client device;
detecting a first comment on the document from the first user, wherein the first comment is generated by the first user through interacting with the touch screen display;
receiving a second comment on the document from the remote server system, wherein the second comment is generated by a second user of a second client device and transmitted to the remote server system through a computer network; and
concurrently displaying, respectively, the first comment and the second comment on the touch screen display.

2. The computer-implemented method of claim 1, further comprising:
in response to a user instruction to close the document with comments,
saving the first comment and the second comment in a storage device coupled to the remote server system, each comment having an associated timestamp; and
terminating the display of the document and the first and second comments on the touch screen display.

3. The computer-implemented method of claim 2, further comprising:
in response to a user instruction to re-open the document with comments,
displaying the document on the touch screen display;
retrieving the first comment and the second comment from the storage device; and
displaying the first comment and the second comment on the touch screen display in a visually-noticeable sequence in accordance with their respective timestamps.

4. The computer-implemented method of claim 3, further comprising:
receiving a third comment on the re-opened document from a third client device; and
concurrently displaying, respectively, the first, second and third comments on the touch screen display.

5. The computer-implemented method of claim 2, further comprising:
in response to a user instruction to re-open the document with comments,
displaying the document on the touch screen display,
retrieving the first comment and the second comment from the storage device;
displaying the first comment and the second comment on the touch screen display in a visually-simultaneous manner.

6. The computer-implemented method of claim 1, further comprising:
updating the first comment on the touch screen display in accordance with a set of user instructions from a respective client device.

7. The computer-implemented method of claim 6, wherein the user instructions include an image of the updated first comment.

8. The computer-implemented method of claim 6, wherein updating the first comment further includes:
removing the first comment from the touch screen display in accordance with an instruction from the second user at the second client device.

9. The computer-implemented method of claim 1, wherein the first comment is displayed on the touch screen display in a first manner and the second comment is displayed on the touch screen display in a second manner that is different from the first manner.

10. The computer-implemented method of claim 9, wherein the first comment is concurrently displayed at the first client device and the second device in the first manner and the second comment is concurrently displayed at the first client device and the second device in the second manner.

11. A server system, comprising:
one or more processing units for executing programs; and
memory for storing data and one or more programs to be executed by the one or more central processing units, the one or more programs including instructions for:
receiving a first comment on a document made by a first user from a first client device and a second comment on the document made by a second user from a second client device, wherein the document is a subject of a web conference supported by the server system;
storing the first and second comments in a data structure associated with the document, each comment having an associated timestamp; and
transmitting, respectively, the first comment to the second client device and the second comment to the first client device such that the first and second comments are concurrently displayed on both the first and second client devices.

12. The server system of claim 11, wherein the one or more programs further include instructions for:
in response to a request to join the web conference from a third user at a third client device,
transmitting the document to the third client device for displaying the document to the third user, and
transmitting the first comment and the second comment to the third client device, wherein the first comment and the second comment are displayed at the third client device in a visually-noticeable sequence in accordance with their respective timestamps.

13. The server system of claim 12, wherein the one or more programs further include instructions for:
receiving a third comment on the document from the third client device;
storing the third comment in the data structure associated with the document; and
transmitting the third comment to the first and second client devices, respectively, such that third comment is concurrently displayed on both the first and second client devices together with the first and second comments.

14. The server system of claim 11, wherein the one or more programs further include instructions for:
in response to a request to join the web conference from a third user at a third client device,
transmitting the document to the third client device for displaying the document to the third user; and
transmitting the first comment and the second comment to the third client device, wherein the first comment and the second comment are displayed at the third client device in a visually-simultaneous manner.

15. The server system of claim 11, wherein the one or more programs further include instructions for:
receiving a request from the first user to update the second comment;
updating the second comment in accordance with the request;
replacing the second comment in the data structure with the modified second comment; and
transmitting the modified second comment to the second client device, wherein the modified second comment is to replace the second comment currently displayed at the second client device.

16. The server system of claim 11, wherein the one or more programs further include instructions for:
receiving a request from the first user to delete the second comment;
eliminating the second comment from the data structure; and
transmitting an instruction to the second client device for eliminating the second comment currently displayed at the second client device.

17. The server system of claim 16, wherein the instruction includes an image of the document without the second comment.

18. The server system of claim 11, wherein the first comment is displayed at the first client device in a first manner and the second comment is displayed at the first client device in a second manner that is different from the first manner.

19. The server system of claim 11, wherein the first comment is concurrently displayed at the first client device and the second device in a first manner and the second comment is concurrently displayed at the first client device and the second device in a second manner.

20. A computer readable-storage medium storing one or more programs for execution by one or more processors of a server system, the one or more programs comprising instructions, which when executed by the one or more processors, cause the server system to:
receive a first comment on a document made by a first user from a first client device and a second comment on the document made by a second user from a second client device, wherein the document is a subject of a web conference supported by the server system;
store the first and second comments in a data structure associated with the document, each comment having an associated timestamp; and
transmit, respectively, the first comment to the second client device and the second comment to the first client device such that the first and second comments are concurrently displayed on both the first and second client devices.

21. The computer readable-storage medium of claim 20, wherein the one or more programs further include instructions for:
in response to a request to join the web conference from a third user at a third client device,
transmitting the document to the third client device for displaying the document to the third user, and
transmitting the first comment and the second comment to the third client device, wherein the first comment and the second comment are displayed at the third client device in a visually-noticeable sequence in accordance with their respective timestamps.

22. The computer readable-storage medium of claim 21, wherein the one or more programs further include instructions for:
receiving a third comment on the document from the third client device;
storing the third comment in the data structure associated with the document; and
transmitting the third comment to the first and second client devices, respectively, such that third comment is concurrently displayed on both the first and second client devices together with the first and second comments.

23. The computer readable-storage medium of claim 20, wherein the one or more programs further include instructions for:
in response to a request to join the web conference from a third user at a third client device,
transmitting the document to the third client device for displaying the document to the third user; and
transmitting the first comment and the second comment to the third client device, wherein the first comment and the second comment are displayed at the third client device in a visually-simultaneous manner.

24. The computer readable-storage medium of claim 20, wherein the one or more programs further include instructions for:
receiving a request from the first user to update the second comment;
updating the second comment in accordance with the request;
replacing the second comment in the data structure with the modified second comment; and
transmitting the modified second comment to the second client device, wherein the modified second comment is to replace the second comment currently displayed at the second client device.

25. The computer readable-storage medium of claim 20, wherein the one or more programs further include instructions for
receiving a request from the first user to delete the second comment;
eliminating the second comment from the data structure; and
transmitting an instruction to the second client device for eliminating the second comment currently displayed at the second client device.

26. The computer readable-storage medium of claim 25, wherein the instruction includes an image of the document without the second comment

27. The computer readable-storage medium of claim 20, wherein the first comment is displayed at the first client device in a first manner and the second comment is displayed at the first client device in a second manner that is different from the first manner.

28. The computer readable-storage medium of claim 20, wherein the first comment is concurrently displayed at the first client device and the second device in a first manner and the second comment is concurrently displayed at the first client device and the second device in a second manner.
